(19) United States
(12) Patent Application Publication
(10) Pub. No.: US 2026/0084672 A1
(43) Pub. Date: Mar. 26, 2026

(54) FRONT-MOUNTED TYPE RESERVOIR ASSEMBLY

(71) Applicant: HL MANDO CORPORATION, Gyeonggi-do (KR)

(72) Inventor: Seunghwan BYUN, Gyeonggi-do (KR)

(21) Appl. No.: 19/016,804

(22) Filed: Jan. 10, 2025

(30) Foreign Application Priority Data
Sep. 23, 2024 (KR) 10-2024-0128565

(51) Int. Cl. B60T 11/26; B60T 17/06

(52) U.S. Cl. CPC B60T 11/26; B60T 17/06

(57) ABSTRACT

Disclosed is a front-mounted type reservoir assembly. A front-mounted type reservoir assembly according to the present embodiment may be installed on a front surface of a hydraulic block of an integrated brake system and include a main reservoir tank having a main reservoir chamber configured to store a pressurized medium therein, and a plurality of oil ports formed on a front surface of the main reservoir tank so that the pressurized medium is introduced or discharged through the plurality of oil ports, and a remote reservoir tank having a first connection port configured to supply the pressurized medium to the main reservoir tank, an injection part configured to inject the pressurized medium, and a remote reservoir chamber configured to store the pressurized medium therein, in which the remote reservoir tank has partition walls configured to increase flow resistance of the pressurized medium to be supplied to the main reservoir tank.

### CROSS-REFERENCE TO RELATED APPLICATIONS

This application claims the priority of Korean Patent Application No. 10-2024-0128565 filed on Sep. 23, 2024, in the Korean Intellectual Property Office, the disclosure of which is incorporated herein by reference.

### BACKGROUND

### Field

The present disclosure relates to a front-mounted type reservoir assembly, and more particularly, to a front-mounted type reservoir assembly mounted on a front surface of a hydraulic block to supply a pressurized medium to an integrated brake system.

### Description of the Related Art

A vehicle is essentially equipped with a brake system for braking the vehicle. Various types of brake systems have been proposed to provide safety for a driver and a passenger.

The brake system in the related art mainly operates in such a way that when the driver pushes a brake pedal, a booster mechanically connected to the brake pedal is used to supply a wheel cylinder with a liquid pressure required to brake the vehicle. However, as there is an increasing demand from the market to implement various braking functions in order to appropriately cope with operational environments of vehicles, integrated dynamic brakes (IDBs) have recently widely proliferated, in which when a driver pushes a brake pedal, a pedal displacement sensor, which detects a displacement of the brake pedal, transmits an electrical signal to indicate a driver's intention to brake, and a liquid pressure supply device operates in response to the electrical signal to supply a wheel cylinder with a liquid pressure required to brake the vehicle.

An integrated brake system may generate a stable, strong braking force by integrating a master booster and an electronic stability control (ESC) device. In general, the integrated brake system includes a configuration in which a pedal displacement sensor operates a motor by outputting an operation of a brake pedal as an electrical signal, a piston pump of a liquid pressure generation device generates hydraulic braking pressure in accordance with an operation of the motor, and an electronic control unit controls the hydraulic pressure and transmits the hydraulic pressure to wheels. In addition, a master cylinder is provided in a hydraulic block equipped with a hydraulic circuit to transmit a pedal effort of a brake pedal directly to a wheel cylinder when the system operates abnormally.

There is provided a reservoir that provides a pressurized medium, such as brake oil, to the integrated brake system to perform a braking operation by means of the integrated brake system described above. Typically, the reservoir stores the pressurized medium therein and is coupled to an upper portion of the master cylinder. In addition, the reservoir may be connected to the piston pump so that the piston pump provided in the liquid pressure generation device of the integrated brake system generates liquid pressure.

The reservoir is installed in various ways to supply the pressurized medium to the integrated brake system. However, there is a problem in that it is difficult to install the reservoir in a limited space in the vehicle.

Meanwhile, there is a tendency toward increasing an area of a bottom surface of the reservoir to increase a capacity of the pressurized medium accommodated in the reservoir. However, there is a problem in that the increase in area of the bottom surface increases an increase in load during a pressing operation, which makes it easy to damage the reservoir.

### SUMMARY

An object to be achieved by the present embodiment is to provide a front-mounted type reservoir assembly capable of easily implementing installation and arrangement of a vehicle.

Another object to be achieved by the present embodiment is to provide a front-mounted type reservoir assembly capable of improving a degree of design freedom and spatial utilization of a vehicle.

Still another object to be achieved by the present embodiment is to provide a front-mounted type reservoir assembly capable of increasing flow resistance and effectively preventing air from being introduced into a brake system.

Yet another object to be achieved by the present embodiment is to provide a front-mounted type reservoir assembly capable of preventing pedal feel and brake performance from deteriorating.

One aspect of the present disclosure may provide a front-mounted type reservoir assembly, which is installed on a front surface of a hydraulic block of an integrated brake system, the front-mounted type reservoir assembly including: a main reservoir tank having a main reservoir chamber configured to store a pressurized medium therein, and a plurality of oil ports formed on a front surface of the main reservoir tank so that the pressurized medium is introduced or discharged through the plurality of oil ports; and a remote reservoir tank having a first connection port configured to supply the pressurized medium to the main reservoir tank, an injection part configured to inject the pressurized medium, and a remote reservoir chamber configured to store the pressurized medium therein, in which the remote reservoir tank has partition walls configured to increase flow resistance of the pressurized medium to be supplied to the main reservoir tank, and in which the partition walls include: a first partition wall having ‘T’ shapes; and a second partition wall having a ring shape.

The partition wall may extend in a perpendicular direction from a bottom surface of the remote reservoir tank.

The first partition wall may be provided on a second surface of the remote reservoir tank that is a surface opposite to a first surface on which the first connection port is formed.

The first partition wall may further include a first-second partition wall provided on a fourth surface that is a surface opposite to a third surface provided between the first surface and the second surface and disposed adjacent to the first connection port.

The second partition wall may be provided at a position corresponding to the injection part.

The second partition wall may include a pair of opening portions formed to be opened in a direction corresponding to a longitudinal direction of the first connection port.

The second partition wall may further include a third partition wall provided on a central portion of the second partition wall and having a cross shape.

The partition walls may further include: a fourth partition wall formed in a direction corresponding to a longitudinal direction of the first connection port; and a fifth partition wall disposed between the fourth partition wall and an inner wall of the remote reservoir tank and provided in a direction orthogonal to the fourth partition wall.

The fourth partition wall may be provided as a pair, and is disposed to be spaced apart from each other at a predetermined interval.

The fifth partition wall may be provided as a plurality, and is disposed in a zigzag shape.

The other end of the fifth partition wall may extend toward the inner wall when one end of the fifth partition wall is fixed to the fourth partition wall, and one end of the fifth partition wall may extend toward the fourth partition wall when the other end of the fifth partition wall is fixed to the inner wall.

A flow path hole may be formed in the fourth partition wall to allow a flow of the pressurized medium stored between the fourth partition wall and the inner wall.

The partition walls may further include a plurality of sixth partition walls provided in a direction orthogonal to the fourth partition wall.

A bottom surface of the remote reservoir tank may include a flat section and an inclined section, and the inclined section may be provided to be inclined so that the pressurized medium flows to the first connection port.

The main reservoir chamber may be divided into a plurality of chambers by one or more partition walls.

The plurality of oil ports may be provided to respectively communicate with the plurality of chambers.

The main reservoir tank may include a second connection port configured to receive the pressurized medium from the remote reservoir tank.

The front-mounted type reservoir assembly may further include: a connection member configured to connect the first connection port and the second connection port so that the pressurized medium in the remote reservoir tank is transferred to the main reservoir tank.

Another aspect of the present disclosure may provide a front-mounted type reservoir assembly, which is installed on a front surface of a hydraulic block of an integrated brake system, the front-mounted type reservoir assembly including: a main reservoir tank having a main reservoir chamber configured to store a pressurized medium therein, and a plurality of oil ports formed on a front surface of the main reservoir tank so that the pressurized medium is introduced or discharged through the plurality of oil ports; and a remote reservoir tank having a first connection port configured to supply the pressurized medium to the main reservoir tank, an injection part configured to inject the pressurized medium, and a remote reservoir chamber configured to store the pressurized medium therein, in which the remote reservoir tank includes: a first partition wall having a ‘T’ shape and provided on at least one of remaining side wall surfaces, except for a first surface on which the first connection port is formed, among a plurality of side wall surfaces constituting the remote reservoir tank; and a second partition wall having a ring shape and provided at a position corresponding to the injection part.

The first partition wall may be provided on a second surface, which is a surface opposite to the first surface, and/or a fourth surface that is a surface opposite to a third surface provided between the first surface and the second surface and disposed adjacent to the first connection port.

The front-mounted type reservoir assembly according to the present embodiment may easily implement the installation and arrangement of the vehicle.

The front-mounted type reservoir assembly according to the present embodiment may improve the degree of design freedom and spatial utilization of the vehicle.

The front-mounted type reservoir assembly according to the present embodiment may increase the flow resistance of the pressurized medium and effectively prevent air from being introduced into the brake system.

The front-mounted type reservoir assembly according to the present embodiment may prevent the pedal feel and brake performance from deteriorating.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view illustrating a front-mounted type reservoir assembly according to the embodiment of the present disclosure;

FIG. 2 is an exploded perspective view illustrating a remote reservoir tank of the front-mounted type reservoir assembly according to the embodiment of the present disclosure;

FIG. 3 is a perspective view illustrating a remote lower body according to the embodiment of the present disclosure when viewed at another angle;

FIG. 4 is a top plan view illustrating the inside of the remote lower body according to the embodiment of the present disclosure;

FIG. 5 is a side view illustrating the remote lower body according to the embodiment of the present disclosure;

FIG. 6 is a perspective view illustrating a state in which a main reservoir tank of the front-mounted type reservoir assembly according to the embodiment of the present disclosure is mounted on a front surface of a hydraulic block of an integrated brake system;

FIG. 7 is a perspective view illustrating the main reservoir tank of the front-mounted type reservoir assembly according to the embodiment of the present disclosure; and

FIG. 8 is a perspective view illustrating the hydraulic block according to the embodiment of the present disclosure.

### DETAILED DESCRIPTION OF THE EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Hereinafter, embodiments of the present disclosure will be described in detail with reference to the accompanying drawings. The following embodiments are presented to sufficiently provide the spirit of the present disclosure to those skilled in the art to which the present disclosure pertains. The present disclosure is not limited to the embodiments presented herein and may be specified as other aspects. The constituent elements irrelevant to the description of the present disclosure will be omitted from the drawings to clearly describe the present disclosure. The sizes of the constituent elements may be somewhat exaggerated for purposes of understanding.

A front-mounted type reservoir assembly according to an embodiment of the present disclosure may be mounted on a front surface of a hydraulic block 10 to provide a pressurized medium to an integrated brake system. Therefore, prior to the description of a configuration of a front-mounted type reservoir assembly 1, the integrated brake system will be briefly described.

In general, the integrated brake system may include a master cylinder connected to a brake pedal, a liquid pressure generation device configured to measure a displacement of the brake pedal and generate liquid pressure, a hydraulic block having a plurality of flow paths to transmit liquid pressure, which is generated from the master cylinder or the liquid pressure generation device, to a wheel cylinder, and an electronic control unit configured to control a flow of the liquid pressure. In this case, the master cylinder and a piston pump of the liquid pressure generation device may be provided in the hydraulic block and connected to the flow path. In addition, solenoid valves are provided at appropriate positions in the plurality of flow paths to selectively allow brake oil to flow. Therefore, the electronic control unit performs a braking operation by controlling the flow of the liquid pressure to be transmitted to the wheel cylinder by adjusting the solenoid valves.

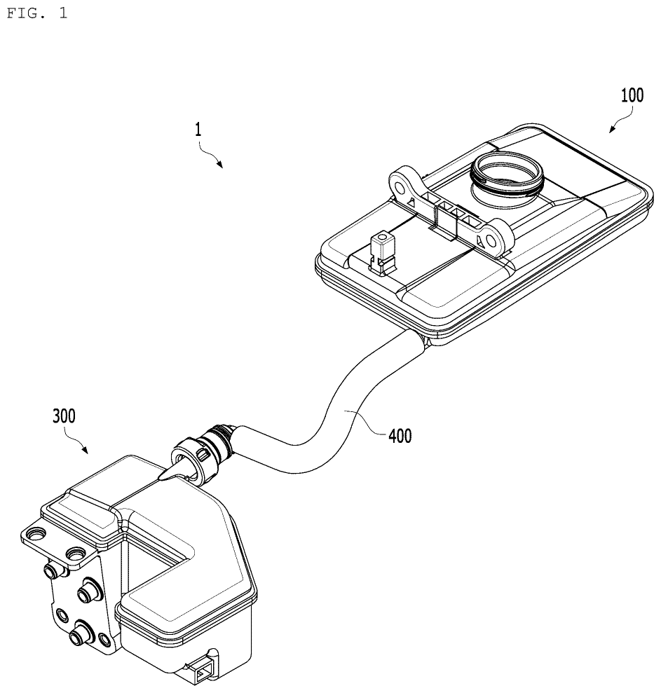

FIG. 1 is a perspective view illustrating the front-mounted type reservoir assembly 1 according to the present embodiment.

With reference to FIG. 1, the front-mounted type reservoir assembly 1 according to the present embodiment may include a remote reservoir tank 100 configured to receive and store a pressurized medium, and a main reservoir tank 300 connected to the remote reservoir tank and having a plurality of oil ports. In this case, the main reservoir tank 300 may be mounted on a front surface of the hydraulic block 10 and configured to provide the pressurized medium to the integrated brake system.

The remote reservoir tank 100 according to the embodiment of the present disclosure is configured to supply the pressurized medium to the main reservoir tank 300. Therefore, the remote reservoir tank 100 may be provided to be spaced apart from an upper side of the main reservoir tank 300 at a predetermined interval.

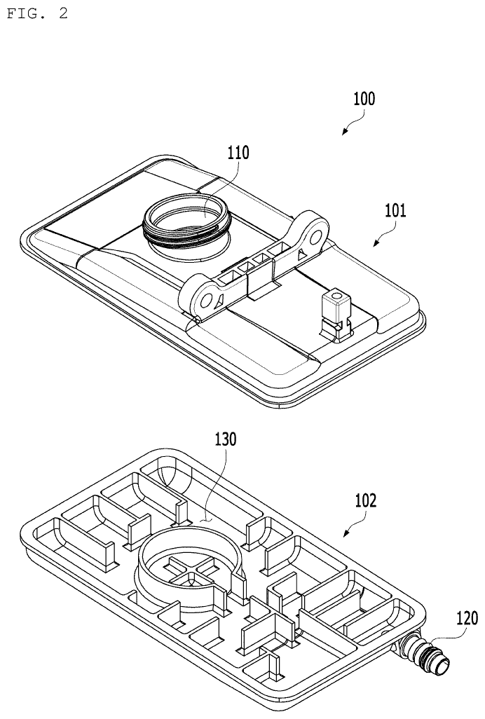

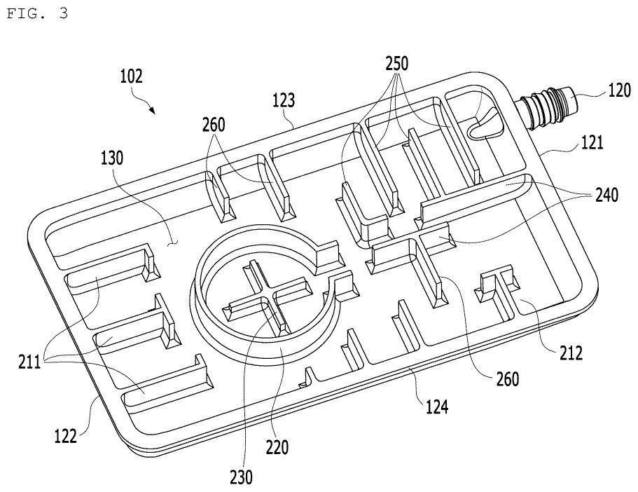

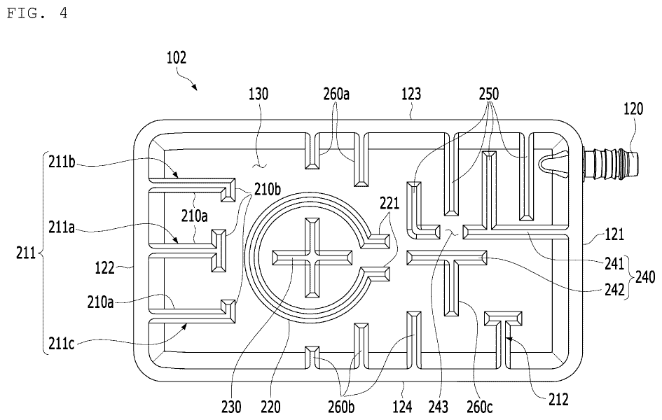

FIG. 2 is an exploded perspective view illustrating the remote reservoir tank of the front-mounted type reservoir assembly according to the embodiment of the present disclosure, FIG. 3 is a perspective view illustrating a remote lower body according to the embodiment of the present disclosure when viewed at another angle, and FIG. 4 is a top plan view illustrating the inside of the remote lower body according to the embodiment of the present disclosure.

With reference to FIGS. 1 to 4, the remote reservoir tank 100 may be formed by coupling a remote upper body 101 and a remote lower body 102, and a space for accommodating the pressurized medium is formed in the remote reservoir tank 100, such that the remote reservoir tank 100 may store the pressurized medium injected from the outside.

The remote upper body 101 and the remote lower body 102 may be integrated by being coupled by thermal bonding.

The remote reservoir tank 100 may include an injection part 110 configured to inject the pressurized medium, a first connection port 120 configured to supply the pressurized medium to the main reservoir tank 300, and a remote reservoir chamber 130 configured to store the pressurized medium therein.

The injection part 110 may be provided on the remote upper body 101, and the first connection port 120 may be provided on the remote lower body 102.

The injection part 110 is formed at an upper side of the remote upper body 101, and the pressurized medium is introduced through the injection part 110. The injection part 110 may have a cylindrical shape and be formed to be inclined toward one side of the remote upper body 101 so that the pressurized medium is easily injected. In this case, the inside of the injection part 110 may be opened to define a passageway through which the pressurized medium is supplied.

Meanwhile, although not illustrated, a cap may be installed on an upper portion of the injection part 110 and prevent the pressurized medium from leaking to the outside. The cap may be attached or detached. When the cap is mounted on the upper portion of the injection part 110, the cap may close the injection part 110 and prevent air, foreign substances, and the like from being introduced into the remote reservoir tank 100. In addition, in case that the cap is separated from the injection part 110, the pressurized medium may be supplied into the remote reservoir tank 100.

A filter may be provided on a lower portion of the injection part 110. The filter may be connected to the lower portion of the injection part 110 and filter the pressurized medium to be injected through the injection part 110. That is, foreign substances in the pressurized medium to be injected into the remote reservoir tank 100 may be removed by the filter. The filter may be integrated with the remote upper body 101. The filter may be formed integrally when the remote upper body 101 is formed, which may improve the working efficiency.

The first connection port 120 may be integrated with the remote lower body 102. The first connection port 120 may be connected to a second connection port 310 of the main reservoir tank 300 by a connection member 400 to be described below. In this case, the remote reservoir tank 100 may be provided at a position higher than the main reservoir tank 300, such that the pressurized medium may be easily transferred to the main reservoir tank 300.

The remote reservoir chamber 130 is a space defined in the remote reservoir tank 100 when the remote upper body 101 and the remote lower body 102 of the remote reservoir tank 100 are coupled. The remote reservoir chamber 130 may store the pressurized medium supplied to the remote reservoir tank 100.

Partition walls 200 may be provided in the remote reservoir tank 100 to increase flow resistance of the pressurized medium guided to the first connection port 120. Meanwhile, the pressurized medium guided to the first connection port 120 may be supplied to the second connection port 310 of the main reservoir tank 300 through the connection member 400. The details will be described below.

The partition walls 200 may extend in a perpendicular direction from a bottom surface of the remote reservoir tank 100.

Specifically, the partition walls 200 according to the embodiment of the present disclosure may include first partition walls 210 having ‘T’ shapes, and a second partition wall 220 having a ring shape.

The first partition walls 210 may include first-first partition walls 211 provided on a second surface 122 of the remote reservoir tank 100 that is a surface opposite to a first surface 121 on which the first connection port 120 is formed. Meanwhile, the first connection port 120 may be provided at an upper side of the first surface 121, i.e., an upper side based on FIG. 4.

Specifically, the first-first partition walls 211 may be provided as a plurality of first-first partition walls 211, and all the plurality of first-first partition walls 211 have ‘T’ shapes. In the present disclosure, the ‘T’ shape refers to a shape including a first unit 210a having one end fixed to one of a plurality of side wall surfaces constituting the remote reservoir tank 100, the first unit 210a extending toward the opposite side wall surface, and a second unit 210b extending in a direction orthogonal to the first unit 210a while passing through the other end of the first unit 210a. The ‘T’ shapes substantially include all a ‘T’ shape, a ‘┌’ shape, and a ‘┐’ shape. Meanwhile, the side wall surfaces of the remote reservoir tank 100 refer to inner walls, except for a bottom surface of the remote lower body 102. Particularly, the side wall surfaces of the remote reservoir tank 100 may include the second surface 122, a third surface 123, and a fourth surface 124, except for the first surface 121 on which the first connection port 120 is formed.

With reference to FIG. 4, the first-first partition walls 211 may be provided as a plurality of first-first partition walls 211 so that one end of each of the first-first partition walls 211 is fixed to the second surface 122 of the remote lower body 102 of the remote reservoir tank 100, and each of the first-first partition walls 211 has a ‘T’ shape toward the first surface 121.

All the plurality of first-first partition walls 211 may be provided to have ‘T’ shapes. However, in order to maintain a basic capacity of the pressurized medium stored in the remote reservoir tank 100, the first-first partition walls 211 may be disposed such that based on a first-first partition wall 211a having a ‘T’ shape, a first-first partition wall 211b having a ‘┌’ shape is provided at an upper side, and a first-first partition wall 211c having a ‘┐’ shape is provided at a lower side.

The first-first partition wall 211a may be provided such that one end thereof is fixed at a middle position on the second surface 122. One end of each of the first-first partition walls 211b and 211c, which are respectively disposed at the upper and lower sides of the first-first partition wall 211a, may be fixed to the second surface 122 so that the first-first partition walls 211b and 211c are spaced apart from the first-first partition wall 211a at the same interval.

The first partition walls 210 may further include a first-second partition wall 212 provided on the fourth surface 124 that is a surface opposite to the third surface 123 disposed adjacent to the first connection port and provided between the first surface 121 and the second surface 122.

The first-second partition wall 212 may be provided to have a ‘T’ shape toward the third surface 123 and have one end fixed to the fourth surface 124 of the remote lower body 102 of the remote reservoir tank 100.

In order to reinforce a portion of the remote reservoir tank 100 that has relatively low pressure resistance, the first-second partition wall 212 may be provided on the fourth surface 124 and disposed adjacent to the first surface 121 on which the first connection port 120 is formed.

In the remote reservoir tank 100 according to the embodiment of the present disclosure, the first-first partition wall 211 and the first-second partition wall 212 are respectively provided on the second surface 122 and the fourth surface 124 of the remote lower body 102, such that a portion, which is easily damaged during a pressing operation, may be effectively reinforced, which may improve the pressure resistance. In addition, the application of the reinforcement structure does not decrease a capacity of the pressurized medium, such that the basic capacity may be maintained, and the reinforcement effect may be implemented.

The second partition wall 220 may be provided at a position corresponding to the injection part 110 formed on the remote upper body 101 of the remote reservoir tank 100.

The second partition wall 220 may have a ring shape to fit a shape of the injection part 110 with a cylindrical shape and include a pair of opening portions 221 formed to be opened in a direction corresponding to a longitudinal direction of the first connection port 120.

That is, the pair of opening portions 221 is provided to be directed toward the first surface 121 on which the first connection port 120 is formed, such that the pressurized medium injected into the injection part 110 may flow toward the first connection port 120 while passing through a passageway formed by the pair of opening portions 221. In this case, the second partition wall 220 may be provided to have the same height as the first partition wall 210. In this case, the height means a degree to which the second partition wall 220 extends in the perpendicular direction from the bottom surface of the remote lower body 102 of the remote reservoir tank 100.

The partition walls may further include a third partition wall 230 provided on a central portion of the second partition wall 220 and having a cross shape.

The third partition wall 230 may have a cross shape and be provided on the central portion of the second partition wall 220 having a ring shape. In this case, the third partition wall 230 may be provided to be lower in height than the second partition wall 220.

In the related art, there is a problem in that the partition wall begins to be damaged from the remote lower body 102 corresponding to the injection part 110 formed on the remote upper body 101, and eventually, the partition wall is damaged along a thermal bonding line between the remote upper body 101 and the remote lower body 102. In the remote reservoir tank 100 according to the embodiment of the present disclosure, the second partition wall 220 and the third partition wall 230 are provided on the remote lower body 102, such that a portion of the remote lower body 102, which corresponds to the injection part 110 that receives a relatively large amount of pressure, may be reinforced, which may improve the pressure resistance.

The partition walls 200 according to the embodiment of the present disclosure may further include fourth partition walls 240 formed in a direction corresponding to the longitudinal direction of the first connection port 120, and fifth partition walls 250 disposed between the fourth partition walls 240 and the inner wall of the remote reservoir tank 100 and provided in a direction orthogonal to the fourth partition wall 240.

The fourth partition walls 240 may be provided as a pair of fourth partition walls 240 disposed to be spaced apart from each other at a predetermined interval. Specifically, the fourth partition walls 240 may include a fourth-first partition wall 241 extending toward the second surface 122 and having one end fixed to the first surface 121 on which the first connection port 120 is formed, and a fourth-second partition wall 242 formed to be spaced apart from the fourth-first partition wall 241.

The fourth-first partition wall 241 may be provided adjacent to the first connection port 120, and the fifth partition wall 250 may be included between the fourth-first partition wall 241 and the third surface 123 of the remote lower body 102 and provided in a direction orthogonal to the fourth-first partition wall 241.

The fifth partition walls 250 may be provided as a plurality of fifth partition walls 250 and disposed in a zigzag shape. That is, in case that one end of the fifth partition wall 250 is fixed to the fourth-first partition wall 241, the other end of the fifth partition wall 250 may extend toward the third surface 123. In case that the other end of the fifth partition wall 250 is fixed to the third surface 123, and one end of the fifth partition wall 250 may extend toward the fourth-first partition wall 241. Therefore, the pressurized medium may flow in a zigzag shape along the fifth partition wall 250.

Meanwhile, a flow path hole 243 may be formed in the fourth-first partition wall 241 to allow the flow of the pressurized medium. Therefore, the pressurized medium with the increased flow resistance between the fourth-first partition wall 241 and the inner wall may flow to the first connection port 120 by the flow path hole 243. Therefore, it is possible to prevent the pressurized medium in the remote reservoir tank 100 from being quickly discharged to the first connection port 120, thereby preventing the introduction of air.

The fourth-second partition wall 242 may be formed to be spaced apart from the fourth-first partition wall 241. Specifically, the fourth-second partition wall 242 may be provided at a position corresponding to the flow path hole 243 formed in the fourth-first partition wall 241, and the fourth-second partition wall 242 may be formed to be longer in length than the flow path hole 243. In this case, the length of the flow path hole 243 refers to a reference length in the longitudinal direction of the first connection port 120. That is, the fourth-second partition wall 242 may be provided to have a relatively smaller length than the fourth-first partition wall 241. Therefore, the basic capacity of the pressurized medium accommodated in the remote reservoir tank 100 may be maintained, and the reinforcement effect implemented by the fourth partition wall 240 may be improved.

The partition walls 200 according to the embodiment of the present disclosure may further include a plurality of sixth partition walls 260 provided in a direction orthogonal to the fourth partition wall 240.

The sixth partition walls 260 may be provided in the same direction as the fifth partition walls 250 and distributed on the third surface 123, the fourth surface 124, and the inside of the remote lower body 102.

In an exemplary example, a pair of sixth partition walls 260a may be formed on the third surface 123 of the remote lower body 102 and spaced apart from each other, and a plurality of sixth partition walls 260b may be formed on the fourth surface 124 and spaced apart from one another.

One end of each of the pair of sixth partition walls 260a may be fixed to the third surface 123. The pair of sixth partition walls 260a may extend toward the fourth surface 124 and be formed to have different lengths. In this case, the lengths of the sixth partition walls 260a may be appropriately adjusted so that constant intervals between the sixth partition walls 260a and the second partition wall 220, which is provided at the periphery of the sixth partition walls 260a, may be maintained to ensure the passageway for the pressurized medium.

One end of each of the plurality of sixth partition walls 260b may be fixed to the fourth surface 124. The plurality of sixth partition walls 260b may extend toward the third surface 123 and be formed to have different lengths. In this case, the lengths of the sixth partition walls 260b may be appropriately adjusted so that constant intervals between the sixth partition walls 260b and the second partition wall 220 and the fourth-second partition wall 242, which are provided at the periphery of the sixth partition walls 260b, may be maintained to ensure the passageway for the pressurized medium.

The sixth partition walls 260 may further include a sixth partition wall 260c formed to be orthogonal to the fourth-second partition wall 242.

One end of the sixth partition wall 260c may be fixed to the fourth-second partition wall 242, and the sixth partition wall 260c may extend toward the fourth surface 124. Therefore, the pressurized medium, which has increased flow resistance and is stored in the space between the fourth-second partition wall 242 and the fourth surface 124, may flow to the first connection port 120 through the flow path hole 243.

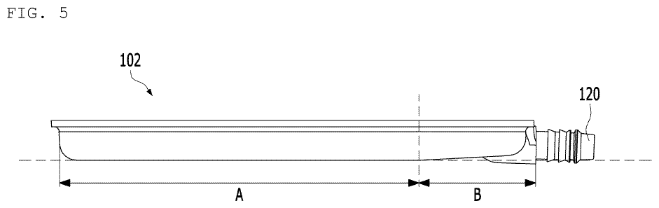

FIG. 5 is a side view illustrating the remote lower body according to the embodiment of the present disclosure.

With reference to FIG. 5, the bottom surface of the remote lower body 102 of the remote reservoir tank 100 may have a flat section A and an inclined section B.

The flat section A may extend from a lower portion of the first surface 121 to a lower portion of the second surface 122 and include some of the first-first partition wall 211, the second partition wall 220, the third partition wall 230, and the sixth partition wall 260 among the partition walls.

The inclined section B may be connected to the flat section A and provided to be inclined toward the first connection port 120 formed on the second surface 122. The inclined section B may include some of the first-second partition wall 212, the fourth partition wall 240, the fifth partition wall 250, and the sixth partition wall 260.

Therefore, the pressurized medium injected into the flat section A may flow to the inclined section B in the state in which flow resistance is increased by the partition walls, and the inclined section B may guide the pressurized medium to the first connection port 120 in the state in which flow resistance is increased.

The main reservoir tank 300 may be mounted on the front surface of the hydraulic block 10 and configured to receive the pressurized medium with the increased flow resistance from the remote reservoir tank 100 with the above-mentioned structure and supply the pressurized medium toward a master cylinder or a hydraulic piston.

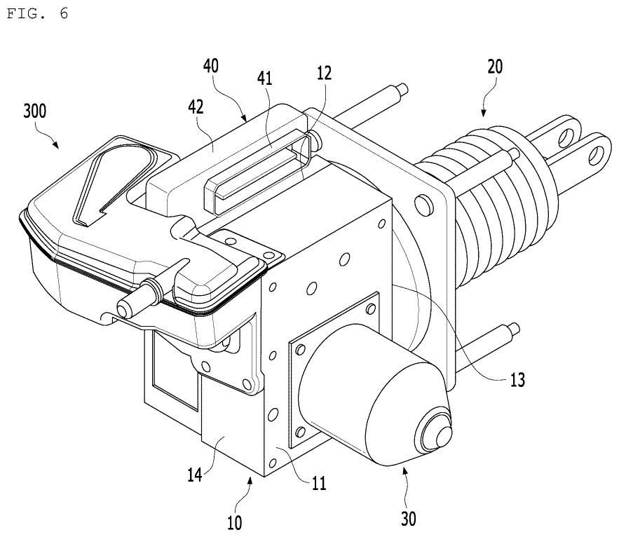

FIG. 6 is a perspective view illustrating a state in which the main reservoir tank of the front-mounted type reservoir assembly according to the embodiment of the present disclosure is mounted on the front surface of the hydraulic block of the integrated brake system.

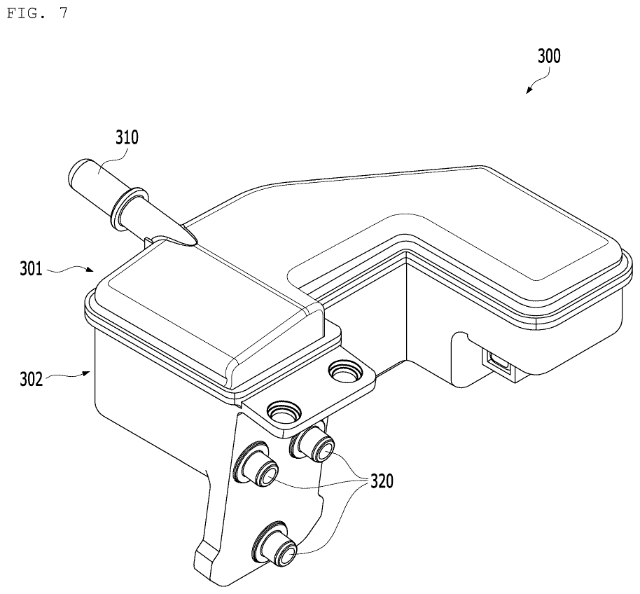

FIG. 7 is a perspective view illustrating the main reservoir tank of the front-mounted type reservoir assembly according to the embodiment of the present disclosure.

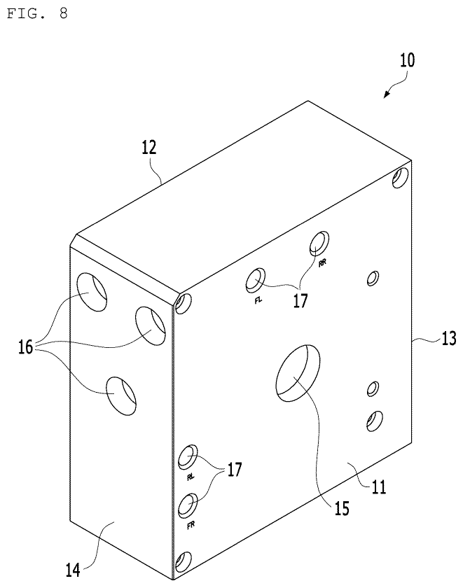

FIG. 8 is a perspective view illustrating the hydraulic block according to the embodiment of the present disclosure.

With reference to FIGS. 6 and 8, the hydraulic block 10 may be provided in a hexahedral shape, a plurality of hydraulic flow paths may be provided in the hydraulic block 10 and define movement routes for the pressurized medium, a plurality of bores may be provided in an outer portion of hydraulic block 10, and various types of component elements, such as a master cylinder 20 and a motor 30, may be mounted in the plurality of bores.

Specifically, the hydraulic block 10 includes a cylinder bore in which the master cylinder 20 connected to a brake pedal and configured to operate in accordance with an operation of the brake pedal is provided, a motor bore 15 in which the motor 30 configured to generate liquid pressure of the pressurized medium, which is required for the braking operation, by being operated by an electrical signal outputted in response to a displacement of the brake pedal is provided, valve bores in which a plurality of valves configured to control the flow of the pressurized medium through the hydraulic flow paths is provided, and reservoir bores 16 configured to communicate with the main reservoir tank 300 configured to accommodate the pressurized medium.

The motor bore 15 may be provided in a first surface 11 of the hydraulic block 10 that has a relatively large area, and an electronic control unit 40 may be provided on a second surface 12 that has a relatively large area and is a surface opposite to the first surface 11. The valve bores, in which the plurality of valves is provided, may also be provided in the second surface 12 and electrically connected to the electronic control unit 40 mounted on the second surface 12.

Meanwhile, the electronic control unit 40 may be configured to control the operations of the motor 30 and the valves on the basis of information on the displacement of the brake pedal or information detected by various types of sensors.

The electronic control unit 40 may include a circuit board provided on the second surface 12 of the hydraulic block 10 that is opposite to the first surface 11 on which the motor 30 is disposed, and the circuit board may be connected to the valves mounted in the valve bores and configured to receive power from a power supply part or receive an electrical signal through a signal transmission part. In addition, the electronic control unit may include a connector 41 configured to supply power to the circuit board or transmit an electrical signal to the circuit board, and a housing 42 configured to accommodate the circuit board therein and having an outer surface on which the connector is provided.

The connector 41 may be positioned at an upper side of the upper surface of the hydraulic block 10 and disposed in a forward/rearward direction on the housing 42. In order to prevent a line or the like, which is connected to the connector 41, from interfering with peripheral component elements, the connector 41 may be disposed to be introduced and coupled in a direction corresponding to a direction of a thickness between the first surface 11 and the second surface 12 of the hydraulic block 10. Therefore, it is possible to minimize interference and contact between the line and the peripheral component element and minimize an increase in size in an upward/downward direction.

The housing 42 is mounted on the second surface 12 of the hydraulic block 10 and has an accommodation space for accommodating therein a controller configured to control the motor 30 and the plurality of valves. In order to form the accommodation space, the housing 42 may include a housing body opened at one side thereof, and a cover coupled to the opened side of the housing body.

The power supply part (not illustrated) may supply power from a battery of the vehicle to the circuit board. The power supply part may supply and transmit power.

The motor bore 15 and the valve bore may be recessed in the hydraulic block 10 and extend in the direction parallel to the direction of the thickness between the first surface 11 and the second surface 12. The hydraulic piston, which is operated by the motor 30, may be inserted into the motor bore 15 and reciprocate. The valve bore may also be recessed in the second surface 102 in the same axial direction as the motor bore. Various types of solenoid valves and check valves, which control the flow of the pressurized medium flowing along the hydraulic flow paths, may be inserted and mounted into the valve bores.

The master cylinder 20 connected to the brake pedal may be provided in the cylinder bore. The cylinder bore may be recessed and extended in a third surface 13 of the hydraulic block 10 that defines a rear side surface between the first surface 11 and the second surface 12.

The cylinder bore may be formed in the hydraulic block 10 and extend in the forward/rearward direction, and an operation axis of the master cylinder 20 may also be provided in a direction parallel to the forward/rearward direction of the hydraulic block 10. The axis of the master cylinder 20 is disposed in the direction parallel to the forward/rearward direction of the hydraulic block 10, and an axis of the motor 30 is disposed in the direction parallel to the direction of the thickness of the hydraulic block 10, such that the axis of the master cylinder 20 and the axis of the motor 30 may be orthogonal to each other, and as a result, the arrangements of the master cylinder 20 and the motor 30 may be efficiently implemented.

The reservoir bore 16 may be formed in a fourth surface 14 of the hydraulic block 10 that defines a front side surface between the first surface 11 and the second surface 10. In case that the reservoir bore 16 is provided in the upper surface of the hydraulic block 10, the size of the product in the upward/downward direction may increase because the main reservoir tank 300 is provided at an upper side of the hydraulic block 10. Therefore, in the hydraulic block 10 according to the present embodiment, the reservoir bore 16, which communicates with the main reservoir tank 300, is provided in the fourth surface 14, i.e., the front side surface, instead of the upper surface, thereby suppressing increases in size and volume in the upward/downward direction.

The main reservoir tank 300 may receive the pressurized medium from the above-mentioned remote reservoir tank 100 and store the pressurized medium. The main reservoir tank 300 may communicate with the hydraulic block 10 through the reservoir bore 16 and supply the pressurized medium.

With reference to FIG. 7, the main reservoir tank 300 may be formed by coupling a main upper body 301 and a main lower body 302.

The main upper body 301 and the main lower body 302 may constitute one body by being coupled by thermal bonding.

The main reservoir tank 300 may have a main reservoir chamber configured to store the pressurized medium therein. That is, the main reservoir chamber is a space formed in the main reservoir tank 300 when the main upper body 301 and the main lower body 302 of the main reservoir tank 300 are coupled. Therefore, the main reservoir chamber may store the pressurized medium to be supplied to the integrated brake system.

The main reservoir tank 300 may include one or more partition walls configured to divide the main reservoir chamber into a plurality of chambers. In this case, the main reservoir chamber may be divided into three chambers to supply the pressurized medium to a hydraulic piston pressure chamber and two master chambers formed in the master cylinder.

The main reservoir tank 300 may have a plurality of oil ports 320 coupled to the front surface, i.e., the fourth surface 14 of the hydraulic block 10 and configured to supply the pressurized medium. The plurality of oil ports 320 may be integrated with the main lower body 302 and provided to respectively communicate with the plurality of chambers made by dividing the main reservoir chamber.

In an exemplary example, in case that the main reservoir chamber is divided into first to third main reservoir chambers, the oil ports 320 may include a first oil port provided to communicate with the first main reservoir chamber, a second oil port provided to communicate with the second main reservoir chamber, and a third oil port provided to communicate with the third main reservoir chamber. Therefore, the pressurized medium stored in the main reservoir chambers may be introduced or discharged through the oil ports.

The first and second oil ports may be respectively connected to first and second master chambers formed in the master cylinder 20, and the third oil port may be connected to the hydraulic piston pressure chamber. The connection structure is an example, and the present disclosure is not limited thereto. That is, the first and third oil ports may be connected to the master cylinder, and the second and third oil ports may be connected to the master cylinder.

Meanwhile, in case that the above-mentioned main reservoir chamber is divided into the first to third main reservoir chambers, the reservoir bores 16 may be provided as a plurality of reservoir bores 16 so that the pressurized medium smoothly flow between the first to third main reservoir chambers of the main reservoir tank 300, the pressure chamber, and the master chamber provided in the hydraulic block 10. Specifically, the reservoir bores 16 may include a first reservoir bore configured to communicate with the first master chamber to allow the chambers, which are separated in the main reservoir tank 300, to communicate with the hydraulic block 10, a second reservoir bore configured to communicate with the second master chamber, and a third reservoir bore configured to communicate with the pressure chamber. However, the connection structure is an example, and the present disclosure is not limited thereto.

In the present disclosure, as described above, the example has been described in which the main reservoir chamber is divided into the three chambers, the three oil ports are provided in the main reservoir chamber while corresponding to the three chambers and communicate with the chambers, and the three reservoir bores are provided in the front surface, i.e., the fourth surface 14 of the hydraulic block 10 while corresponding to the oil ports and communicate with the chambers. However, the present disclosure is not necessarily limited thereto.

The specific structure in the main reservoir chamber and the division method may be variously implemented. The partition walls are additionally provided to increase the flow resistance of the pressurized medium stored in the main reservoir chamber, which may prevent air from being introduced into the brake system under vehicle traveling conditions and some braking conditions.

The main reservoir tank 300 may include the second connection port 310 formed to receive the brake oil from the above-mentioned remote reservoir tank 100.

The second connection port 310 may be integrated with the main upper body 301.

The second connection port 310 may be connected to the first connection port 120 of the remote reservoir tank 100 through the connection member 400 and receive the pressurized medium from the remote reservoir tank 100. In this case, the remote reservoir tank 100 may be provided at a position higher than the main reservoir tank 300, such that the pressurized medium may be easily transferred to the main reservoir tank 300.

One end of the connection member 400 is connected to the first connection port 120, and the other end of the connection member 400 is connected to the second connection port 310, such that the pressurized medium in the remote reservoir tank 100 is transferred to the main reservoir tank 300. The connection member may be provided as a rubber hose so that the pressurized medium is easily transferred even though the installation position of the remote reservoir tank 100 or the main reservoir tank 300 is selectively changed.

With reference to FIG. 6, the main reservoir tank 300 according to the embodiment of the present disclosure may be mounted on the front surface of the hydraulic block 10 and have a ‘ [symbol] ’ shape to surround the electronic control unit 40. The application of this structure may meet various needs of customers during vehicle package layout processes. However, in the present disclosure, the ‘ [symbol] ’ shape of the main reservoir tank 300 is just an example, and the present disclosure is not necessarily limited thereto. Specifically, the main reservoir tank 300 may be mounted on the front surface of the hydraulic block 10 and extend in the upward/downward direction.

In the front-mounted type reservoir assembly 1 according to the present embodiment described above, the partition walls having ‘T’ shapes and ring shapes are applied to the remote reservoir tank 100, which may increase the flow resistance of the injected pressurized medium and increase the pressure resistance. In addition, the pressurized medium with the increased flow resistance may be supplied to the main reservoir tank 300, which may effectively prevent damage to the tank caused by the pressing operation.

What is claimed is:

1. A front-mounted type reservoir assembly, which is installed on a front surface of a hydraulic block of an integrated brake system, the front-mounted type reservoir assembly comprising:
a main reservoir tank having a main reservoir chamber configured to store a pressurized medium therein, and a plurality of oil ports formed on a front surface of the main reservoir tank so that the pressurized medium is introduced or discharged through the plurality of oil ports; and
a remote reservoir tank having a first connection port configured to supply the pressurized medium to the main reservoir tank, an injection part configured to inject the pressurized medium, and a remote reservoir chamber configured to store the pressurized medium therein,
wherein the remote reservoir tank has partition walls configured to increase flow resistance of the pressurized medium to be supplied to the main reservoir tank, and
wherein the partition walls comprise:
a first partition wall having ‘T’ shape; and
a second partition wall having a ring shape.

2. The front-mounted type reservoir assembly of claim 1, wherein the partition wall extends in a perpendicular direction from a bottom surface of the remote reservoir tank.

3. The front-mounted type reservoir assembly of claim 1, wherein the first partition wall comprise a first-first partition wall provided on a second surface of the remote reservoir tank that is a surface opposite to a first surface on which the first connection port is formed.

4. The front-mounted type reservoir assembly of claim 3, wherein the first partition wall further comprise a first-second partition wall provided on a fourth surface that is a surface opposite to a third surface provided between the first surface and the second surface and disposed adjacent to the first connection port.

5. The front-mounted type reservoir assembly of claim 1, wherein the second partition wall is provided at a position corresponding to the injection part.

6. The front-mounted type reservoir assembly of claim 5, wherein the second partition wall comprises a pair of opening portions formed to be opened in a direction corresponding to a longitudinal direction of the first connection port.

7. The front-mounted type reservoir assembly of claim 5, wherein the second partition wall further comprises a third partition wall provided on a central portion of the second partition wall and having a cross shape.

8. The front-mounted type reservoir assembly of claim 1, wherein the partition walls further comprise:
a fourth partition wall formed in a direction corresponding to a longitudinal direction of the first connection port; and
a fifth partition wall disposed between the fourth partition wall and an inner wall of the remote reservoir tank and provided in a direction orthogonal to the fourth partition wall.

9. The front-mounted type reservoir assembly of claim 8, wherein the fourth partition wall is provided as a pair, and is disposed to be spaced apart from each other at a predetermined interval.

10. The front-mounted type reservoir assembly of claim 8, wherein the fifth partition wall is provided as a plurality, and is disposed in a zigzag shape.

11. The front-mounted type reservoir assembly of claim 10, wherein the other end of the fifth partition wall extends toward the inner wall when one end of the fifth partition wall is fixed to the fourth partition wall, and one end of the fifth partition wall extends toward the fourth partition wall when the other end of the fifth partition wall is fixed to the inner wall.

12. The front-mounted type reservoir assembly of claim 9, wherein a flow path hole is formed in the fourth partition wall to allow a flow of the pressurized medium stored between the fourth partition wall and the inner wall.

13. The front-mounted type reservoir assembly of claim 8, wherein the partition walls further comprise a plurality of sixth partition walls provided in a direction orthogonal to the fourth partition wall.

14. The front-mounted type reservoir assembly of claim 1, wherein a bottom surface of the remote reservoir tank includes a flat section and an inclined section, and the inclined section is provided to be inclined so that the pressurized medium flows to the first connection port.

15. The front-mounted type reservoir assembly of claim 1, wherein the main reservoir chamber is divided into a plurality of chambers by one or more partition walls.

16. The front-mounted type reservoir assembly of claim 15, wherein the plurality of oil ports is provided to respectively communicate with the plurality of chambers.

17. The front-mounted type reservoir assembly of claim 1, wherein the main reservoir tank comprises a second connection port configured to receive the pressurized medium from the remote reservoir tank.

18. The front-mounted type reservoir assembly of claim 17, further comprising:
a connection member configured to connect the first connection port and the second connection port so that the pressurized medium in the remote reservoir tank is transferred to the main reservoir tank.

19. A front-mounted type reservoir assembly, which is installed on a front surface of a hydraulic block of an integrated brake system, the front-mounted type reservoir assembly comprising:
a main reservoir tank having a main reservoir chamber configured to store a pressurized medium therein, and a plurality of oil ports formed on a front surface of the main reservoir tank so that the pressurized medium is introduced or discharged through the plurality of oil ports; and
a remote reservoir tank having a first connection port configured to supply the pressurized medium to the main reservoir tank, an injection part configured to inject the pressurized medium, and a remote reservoir chamber configured to store the pressurized medium therein,
wherein the remote reservoir tank comprises:
a first partition wall having a ‘T’ shape and provided on at least one of remaining side wall surfaces, except for a first surface on which the first connection port is formed, among a plurality of side wall surfaces constituting the remote reservoir tank; and
a second partition wall having a ring shape and provided at a position corresponding to the injection part.

20. The front-mounted type reservoir assembly of claim 19, wherein the first partition wall is provided on a second surface, which is a surface opposite to the first surface, and/or a fourth surface that is a surface opposite to a third surface provided between the first surface and the second surface and disposed adjacent to the first connection port.
